(19) United States
(12) Patent Application Publication
(10) Pub. No.: US 2015/0046228 A1
(43) Pub. Date: Feb. 12, 2015

(54) SYSTEM FOR AND METHOD FOR COMMISSION AND KPI TRACKER AGGREGATION AND CONTEXTUALIZATION

(71) Applicant: Cellco Partnership d/b/a Verizon Wireless, Basking Ridge, NJ (US)

(72) Inventors: Alexander Lamb, Califon, NJ (US); Daniel Peters, Jersey City, NJ (US); Christen M. Heiden, Bridgewater (US); Stephanie Cairns, Basking Ridge, NJ (US); Jeff Brown, Dover, NJ (US)

(73) Assignee: Cellco Partnership d/b/a Verizon Wireless, Basking Ridge, NJ (US)

(21) Appl. No.: 13/960,077

(22) Filed: Aug. 6, 2013

(51) Int. Cl. G06Q 10/06

(52) U.S. Cl. CPC G06Q 10/06393
USPC 705/7.39

(57) ABSTRACT

Exemplary embodiments provide a tool that aggregates data from multiple database sources and application programming interfaces. The tool takes the data collected from the sources and applies one or more pre-defined formulas to the data in order to execute enhanced performance calculations. The tool may receive updated data from the sources at defined intervals. Certain data may be provided in real time. The updated data and/or real time data can be used to refine the calculations and provide updated calculations.

### BACKGROUND INFORMATION

At many business entities, multiple databases and tools are used for storing and measuring performance related data, such as sales quotas, key performance indicators (“KPIs”), and commission data. As a result, there is no single way for an employee or manager to effectively access this performance related data and to set goals for KPIs and commissions or to set a target for sales for a given day or month. Multiple databases must be accessed using different tools. Also, trends in the performance related data cannot be effectively visualized by employees or managers given the multiple databases and tools.

These and other deficiencies exist.

### BRIEF DESCRIPTION OF THE DRAWINGS

The present invention, together with further objects and advantages, may best be understood by reference to the following description taken in conjunction with the accompanying drawings, in the several figures of which like reference numerals identify like elements, and in which:

FIG. 1A depicts a system for data aggregation, processing, and display according to exemplary embodiments.

FIG. 1B depicts a device according to exemplary embodiments.

FIG. 2 depicts a method for data aggregation, processing, and display according to exemplary embodiments.

FIG. 3A depicts an interface for a commission tracker according to exemplary embodiments.

FIG. 3B depicts a strategic product matrix according to exemplary embodiments.

FIG. 3C depicts an accelerator matrix according to exemplary embodiments.

FIG. 4 depicts an interface for tracking KPIs according to exemplary embodiments.

FIG. 5A depicts an interface for mobile goal setting according to exemplary embodiments.

FIG. 5B depicts a second interface for mobile goal setting according to exemplary embodiments.

FIG. 6A depicts an interface for a manager's commission tracker according to exemplary embodiments.

FIG. 6B depicts a second interface for a manager's commission tracker according to exemplary embodiments.

FIG. 6C depicts the second interface for the manager's commission tracker according to exemplary embodiments.

FIG. 7A depicts an interface for KPI tracking for a manager according to exemplary embodiments.

FIG. 7B depicts a second interface for KPI tracking for a manager according to exemplary embodiments.

FIG. 7C depicts the second interface for KPI tracking for the manager according to exemplary embodiments.

### DETAILED DESCRIPTION OF PREFERRED EMBODIMENTS

According to exemplary embodiments, systems and methods may provide a tool that aggregates data from multiple database sources and application programming interfaces (“APIs”). The database source may not communicate with one another in normal operation. The data contained in each database may be accessed separately in each database. For example, the databases may contain data that is accessed through separate systems in normal operation and may be in different formats; therefore, in order to view such data it may be normally required to access each database separately.

The tool takes the data collected from the sources and applies one or more pre-defined formulas to the data in order to execute enhanced performance calculations. The tool may receive updated data from the sources at defined intervals. Certain data may be provided in real time. The updated data and/or real time data can be used to refine the calculations and provide updated calculations. The tool may be deployed to and accessed from a variety of computing platforms and be compatible with a variety of operating systems. For example, the tool may be accessed from desktop computing platforms as well as mobile computing platforms, including smart phones and tablet computing devices. The tool may be web-based such that the tool may accessed through a browser application. On some computing platforms, the tool may be accessed through an application or widget.

The tool may enable commission tracking and calculation, KPI calculation, and goal setting to be fully automated. The tool further eliminates the need for sales representatives to use manual tracking, spreadsheets, or other methods to track sales results. The tool may be available across multiple platforms and operating systems. The tool may be accessible to employees and managers alike of an entity. The tool may have one or more graphical user interfaces (“GUIs”) that display the individual, aggregated, and processed data. Individual data may be raw collected data; aggregated data may be raw data compiled from different sources and in some cases combined from those sources; processed data may be raw data (including aggregated data) that is altered or modified as a result of processing logic and/or application of algorithms or formulas to transform the data. The GUIs may be accessible from a variety of computing platforms, both desktop and mobile. The GUIs may be remotely or locally accessed. The displayed data may be dynamically updated and may be manipulated in a variety of manners using the GUI.

The KPI's may be established by the entity. Each KPI may represent a desired metric or performance parameter that is important to the entity to meet the entity's business goals. The KPI's may be updated as required by the entity to reflect new business goals. The updated KPI's may then be updated in the tool according to exemplary embodiments. In some embodiments, certain KPI's may be relevant only to certain business lines or departments of the entity. Other KPI's may be geographic specific.

In the following figures, while a single illustrative block, module or component is shown, these illustrative blocks, modules or components may be multiplied for various applications or different application environments. In addition, the modules or components may be further combined into a consolidated unit. The modules and/or components may be further duplicated, combined and/or separated across multiple systems at local and/or remote locations. For example, some of the modules or functionality associated with the modules may be supported by a separate application or platform. Other implementations and architectures may be realized.

The description below describes network elements, computers, and components of exemplary embodiments. The elements depicted may be modules of a single larger element. Each of these elements may also include one or more modules. As used herein, the term “module” may be understood to refer to computer implemented executable software, firmware, hardware, and various combinations thereof. Modules however are not to be interpreted as software which is not implemented on hardware, firmware, or recorded on a processor readable recordable storage medium (i.e., modules are not software per se). It is noted that the modules are exemplary. The modules may be combined, integrated, separated, and duplicated to support various applications. Also, a function described herein as being performed at a particular module may be performed at one or more other modules and by one or more other devices instead of or in addition to the function performed at the particular module. Further, the modules may be implemented across multiple devices and other components local or remote to one another. Additionally, the modules may be moved from one device and added to another device, and may be included in both devices.

Exemplary embodiments may include software that is installed on computer hardware to allow the execution of instructions to implement the methods described herein. The software may be tangibly embodied in one or more non-transitory physical media, such as, but not limited to, a compact disc (“CD”), a digital versatile disc (“DVD”), a floppy disk, a hard drive, read only memory (“ROM”), random access memory (“RAM”), and other physical media capable of storing software, or combinations of different media.

Moreover, the figures illustrate various components (e.g., servers, computers, etc.) separately. The functions described as being performed at various components may be performed at other components, and the various components may be combined or separated. Other modifications also may be made.

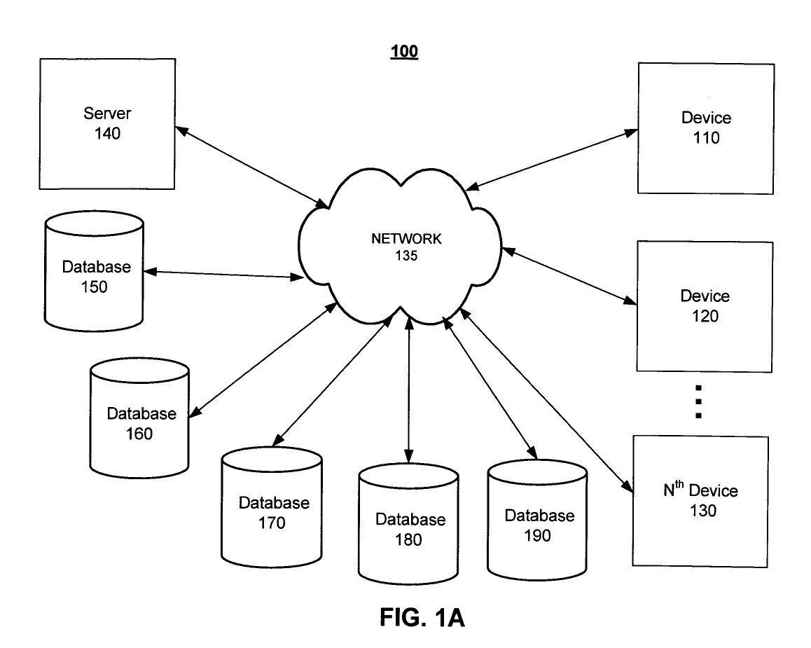

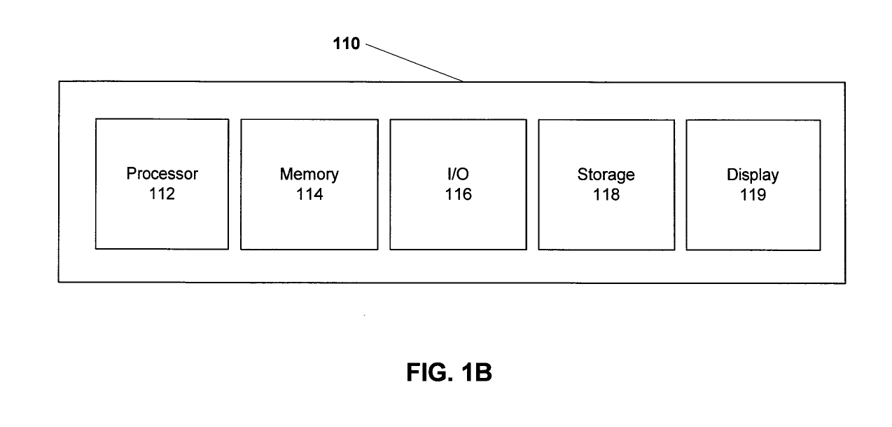

FIG. 1A is a system according to an exemplary embodiment. The system 100 may have a number of components. The components may include devices 110, 120, and 130, a server 140, and databases 150, 160, 170, 180, and 190. The components of the system 100 may be communicatively coupled through a network 135. It should be appreciated that while exemplary interconnections between the components of the system 100 are depicted in FIG. 1A, other interconnections are possible and the various components may be directly connected. The system 100 may be associated with an entity or components of the entity. For example, the entity may be a corporation such as a retail sales entity, or a telecommunications provider. In other embodiments, the system 100 may be associated with more than one entity. The more than one entity may be related to each other. For example, the system 100 may be associated with a number of entities that represent departments, companies, or partners of a larger corporate entity.

The system 100 may have device 110 associated therewith. A second device 120 and an Nth device 130 may be further associated with the system 100. The devices 110, 120 and 130 may be computing devices. It should be appreciated that while three devices are depicted in the system 100, there may be more or less devices. Each of the devices 110, 120, and 130 may include one or more processors for recording, transmitting, receiving, and storing data. The devices 110, 120, 130 may each be single type of computing platform or the devices 110, 120, and 130 may be a mix of computing platforms. For example, the devices 110, 120, and 130 may be a combination of portable and desktop computing devices such as tablet computing devices, smart phones, and personal computers. The devices 110, 120, and 130 may support different operating systems.

The devices 110, 120, and 130 may be access points for users to access the system 100. Each of the devices 110, 120, and 130 may be geographically separated. The devices 110, 120, and 130 may each be communicatively coupled to the network 135.

FIG. 1B depicts an exemplary device 110. It should be appreciated that while the device 110 is depicted in FIG. 1B, devices 120 and 130 may have the same or similar features. As noted above, the device 110 may be a computing device. For example, the device 110 may be a portable or desktop computing device such as a tablet computing device, a smart phone, or a personal computer. The device 110 may have a processor 112, memory 114, input/output (I/O) 116, storage 118, and display 119. The processor 112 may be a single processor or may be more than one processor. The processor 112 may be local to the device 110 or it may be remotely located, such as used in cloud based computing. A combination of local and remote processing may be used. The memory 114 may be transient type memory, such as Random Access Memory (RAM). The storage 118 may be may be network accessible storage and may be local, remote, or a combination thereof. The storage 118 may utilize a redundant array of inexpensive disks (“RAID”), tape, disk, a storage area network (“SAN”), an internet small computer systems interface (“iSCSI”) SAN, a Fibre Channel SAN, a common Internet File System (“CIFS”), network attached storage (“NAS”), a network file system (“NFS”), or other computer accessible storage. In some embodiments the memory 114 and the storage 118 may be combined. The tool may be stored in the memory 114 and/or the storage 118 as an executable program. In other embodiments, the tool may be remotely located and may be accessed through use of a program, such as a browser application or an application. The program may be stored on in the memory 114 and/or the storage 118. The I/O 116 may include communications connectively both external and internal to the device 110. The I/O 116 may include one or more connections for communicatively coupling to one or more other computing devices, components thereof, and/or computer based networks. For example, I/O 116 may be communicatively coupled to transmit and receive data over the network 135 (described below). The I/O 116 may include input devices for interaction with the device 110. The computer based networks may include the network 135 as described below. The display 119 may include one or more displays coupled to the device 110. The display 119 may be local or remote to the device 110. The display 119 may be used to display data and/or graphical user interfaces as described herein.

The network 135 may be a computer-based network. The network 135 may communicatively couple the various components of the system 100. The network 135 may be one or more of a wireless network, a wired network, or a combination of wireless networks and wired networks. For example, the network 135 may include one or more of a fiber optics network, a passive optical network, a cable network, an Internet network, a satellite network (e.g., operating in Band C, Band Ku or Band Ka), a wireless LAN, a Global System for Mobile Communication (“GSM”), a LTE-based network, a Personal Communication Service (“PCS”), a Personal Area Network (“PAN”), D-AMPS, Wi-Fi, Fixed Wireless Data, IEEE 802.11a, 802.11b, 802.15.1, 802.11n and 802.11g or any other wired or wireless network for transmitting and receiving a data signal. In addition, the network 135 may include, without limitation, telephone line, fiber optics, IEEE Ethernet 802.3, a Wide Area Network (“WAN”), a Local Area Network (“LAN”), or a global network such as the Internet. The network 135 may further include one, or any number of the exemplary types of networks mentioned above operating as a stand-alone network or in cooperation with each other. Although the network 135 depicted in FIG. 1A is depicted as a single network, it should be appreciated that according to one or more embodiments, the network may be a plurality of interconnected networks, such as, for example, a service provider network, the Internet, a broadcaster's network, a cable television network, a corporate network, and a home network. The network 135 may have multiple access points.

In the network 135, data may be transmitted and received utilizing a standard telecommunications protocol or a standard networking protocol. For example, data may be transmitted and received using Wireless Application Protocol (“WAP”), Multimedia Messaging Service (“MMS”), Enhanced Messaging Service (“EMS”), Short Message Service (“SMS”), Global System for Mobile Communications (“GSM”)-based systems, LTE-based systems, Code Division Multiple Access (“CDMA”)-based systems, Transmission Control Protocol/Internet (“TCP/IP”) Protocols, or other protocols and systems suitable for transmitting and receiving broadcast data. Data may be transmitted and received wirelessly or may utilize cabled network or telecom connections such as an Ethernet RJ45/Category 5 Ethernet connection, a fiber connection, a traditional phone wireline connection, a cable connection or other wired network connection. For example, the network 135 may use standard wireless protocols such as, for example, IEEE 802.11a, 802.11b 802.11g, and 802.11n. The network 135 may also use protocols for a wired connection, such as IEEE Ethernet 802.3. In some embodiments, the network 135 may utilize one or more protocols of one or more network elements to which it is communicatively coupled. The network 135 may translate to or from other protocols to one or more protocols of network devices.

A server 140 may be communicatively coupled to the network 135. The server 140 may be a single server or multiple servers. The server 140 may have one or more computer processors as well as data storage associated therewith. The data storage may be network accessible storage and may be local, remote, or a combination thereof. The data storage may utilize a redundant array of inexpensive disks (“RAID”), tape, disk, a storage area network (“SAN”), an internet small computer systems interface (“iSCSI”) SAN, a Fibre Channel SAN, a common Internet File System (“CIFS”), network attached storage (“NAS”), a network file system (“NFS”), or other computer accessible storage. In one or more embodiments, the data storage may be a database, such as an Oracle database, a Microsoft SQL Server database, a DB2 database, a MySQL database, a Sybase database, an object oriented database, a hierarchical database, or other database. The data storage may utilize flat file structures for storage of data.

The system 100 may have databases 150, 160, 170, 180, and 190 associated therewith and communicatively coupled to the network 135. Each database 150, 160, 170, 180, and 190 may be a certain type of database, such as an Oracle database, a Microsoft SQL Server database, a DB2 database, a MySQL database, a Sybase database, an object oriented database, a hierarchical database, or other database. The data storage may utilize flat file structures for storage of data. Each database 150, 160, 170, 180, and 190 may be associated with another computing system and may be associated with one or more computing devices or servers that are a part of this other computing system. The databases 150, 160, 170, 180, and 190 may be separate and apart from the data storage associated with the server 140.

According to exemplary embodiments, the database 150 may represent a data warehouse system that serves as a data repository for the entity. The database 150 may be an internal database that is accessible internally only by the entity. For example, the database 150 may contain proprietary data that can only be accessed from inside of the entity. The database 160 may be a resource central database that contains scheduling data for a calendar month including shift times, dates and locations. The scheduling data may be for employees of the entity. The database 170 may be a database for monthly Quota, Return Rate Matrix, Net Add Performance Matrix and Month-to-date results for each measured component of the entity's sales and retail business. The database 180 may be a point of sale database that provides real-time daily performance directly from the point-of-sale system for each employee of the entity.

According to exemplary embodiments, the databases 150, 160, 170, and 180 may provide data input to the server 140. The server 140 may be an aggregation and processing point for the data. The server 140 may then provide the aggregated and processed data to the devices 110, 120, and 130, upon request. The data may be pushed to the server 140 through the network 135 by one or more application programming interfaces. The data may be pushed at predetermined intervals to the server 140. In some embodiments, the data may be pulled by the server 140 at predetermined intervals. It should be appreciated that the server 140 may be communicatively coupled to the databases 150, 160, 170, and 180 directly. For example, the server 140 may be communicatively coupled to the databases 150, 160, 170, and 180 using one or more enterprise serial buses. The databases 150, 160, 170, and 180 may be communicatively to other systems not shown in FIG. 1. The databases may not communicate with one another in normal operation. The data contained in each database may be accessed separately in each database. For example, the databases may contain data that is accessed through separate systems in normal operation and may be in different formats; therefore, in order to view such data it may be normally required to access each database separately.

The database 190 may contain each KPI. The KPI's may be centrally stored and managed using the database 190. The database 190 may provide input of each KPI to the server 140. The KPI's may be stored in a table type format. It should be appreciated that the server 140 may be communicatively coupled to the database 190 directly. For example, the server 140 may be communicatively coupled to the database 190 using an enterprise serial bus.

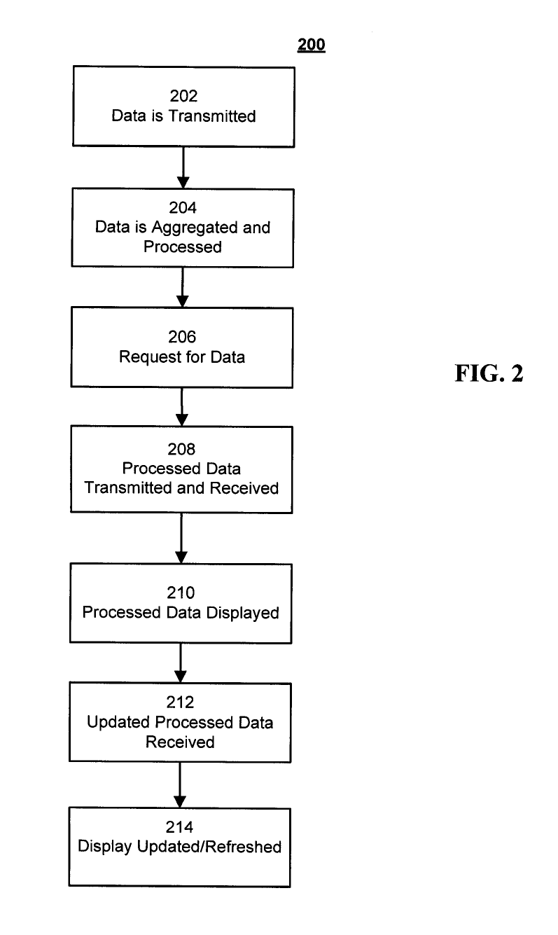

FIG. 2 is a method according to exemplary embodiments. Exemplary method 200 is provided by way of example, as there are a variety of ways to carry out the methods disclosed herein. The method 200 as shown in FIG. 2 may be executed or otherwise performed by one or a combination of various systems, such as a computer implemented system. For example, the system 100 may be used to implement the method 200. Each block shown in FIG. 2 represents one or more processes, methods, and/or subroutines carried out in the exemplary method 200. Each block may have an associated processing machine or the blocks depicted may be carried out through one processor machine.

At block 202, data is transmitted to a server. The data may be transmitted over one or more computer networks. The server may be the server 140 described above. The data may be transmitted from one or more sources. The sources may be one or more databases or computing systems. For example, the data may be from the databases that are described above with respect to the system 100 such as databases 150, 160, 170, and 180. The databases may be communicatively coupled to a single computer network or each database may be communicatively coupled to separate computer networks. In some embodiments, one or more the databases may be communicatively coupled directly to the server.

According to exemplary embodiments, the data may be pushed from the data source to the server. Alternatively, the data may be pulled by the server from the data source. The data may be pushed or pulled at predetermined intervals. For example, the data may be pulled by the server every 15 to 20 minutes. It should be appreciated the longer or shorter intervals may be used. Having the server pull the data at predetermined intervals may assist in managing use of network resources.

The data may be related to employee performance and sales data for an entity. For example, the data transmitted may include:
Number of “Days Worked” and “Days Remaining”;
Quota and Month-to-Date (MTD) data;
Adjusted “Individual Goals” in each commissionable or managed metric (this data may be adjusted by an individual such as an employee)
Current “Month to Date” data;
“Daily Actual” data.

At block 204, the server may aggregate and process the data. The aggregation and processing by the server may be done by a tool or program installed on the server. The server may receive updated data from each of the data sources in real time or at predetermined intervals.

The processing may include an application of one or more formulas and/or algorithms to the received data. For example, the formula definition may include:
(Days Scheduled) minus (Days Worked) equals (Days Remaining)
(Personal Goal) minus (Current Month to Date (MTD) Performance) equals (MTD Performance Deficit)
(Personal Goal) as set within each commissionable metric will calculate (Individual Commission Estimate)
(MTD Performance) divided by (Days Worked) multiplied by (Days Scheduled) equals (Individual Run Rate to Goal) and calculates (Commission Trend)
(MTD Performance Deficit) divided by (Days Remaining) equals (Individual Daily Required)
   Following calculation using the formula and/or algorithm, the aggregated and processed data may be stored by the server in appropriate storage, such as the storage described above with respect to the server 140. It should be appreciated the formula definition above is exemplary, as other formulas or algorithms are possible. For example, the formula above could be altered by adding particular weighting to the data at different points in the formula.

At block 206, a request for the data is made from a computing device. The computing device may be one of computing devices 110, 120, and 130 described above in the system 100. The computing device may be remotely located from the server. The computing device may be operating an instance of the tool according to exemplary embodiments as described herein. The tool may be accessed from the computing device through a browser program or an application.

The request may be made by a manager, a supervisor, or an employee of the entity. The request may require entry of a code or other authentication from the requester. For example, a password or identification code, such as a personal identification number, or an employee number may be required. This authentication may provide validation of the requesters identity to ensure that the data is being sent to an authorized person. A manager or supervisor may be able to request data related to employees who are a part of their department or are directly or indirectly supervised by the manager or supervisor. The provided authentication may be validated by the system to confirm the identity of the request and compare it to the requested data to ensure that the requester has permission to request the data.

At block 208, the requested data is sent by the server to the requesting computing device.

At block 210, the requested data, which includes raw, aggregated, and processed data, is displayed at the requesting computing device using a GUI. It should be appreciated that a series of GUIs may be used to display the processed data. The GUI may allow the user to interact with and manipulate the data.

At block 212, updated processed data is sent to the requesting computing device at certain intervals. In this manner, updates are provided to the displayed data in the GUI. For example, updated processed data may be provided at periodic intervals such as 15 minutes based on receipt of the updated data by the server. It should be appreciated that other intervals may be used. The intervals may be set to balance network loading so as not to interfere with other network traffic. The updated data may be transmitted automatically or a request may be made for updated data. The server may request the updated data in a pull configuration. In some embodiments, the data may be updated automatically and pushed by the database to the server. Manual requests may be made also from the GUI by the user to request the server refresh the displayed data.

At block 214, the displayed data is refreshed and updated with the new processed data. The data refresh may be completed automatically. In some embodiments, the user may request a data refresh. Displayed data based on raw or aggregated data may be refreshed automatically. Processed data may require a request for updated calculated results. In some embodiments, the server may automatically calculate new results based on updated inputs and provide the results to the requesting system for display.

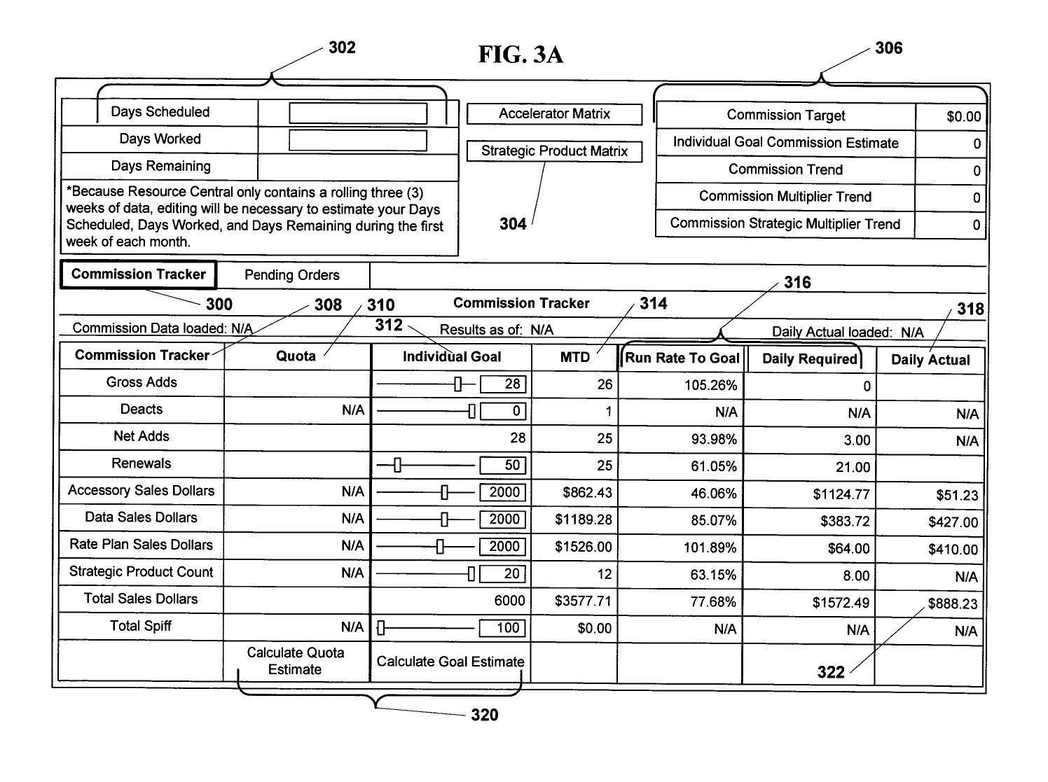

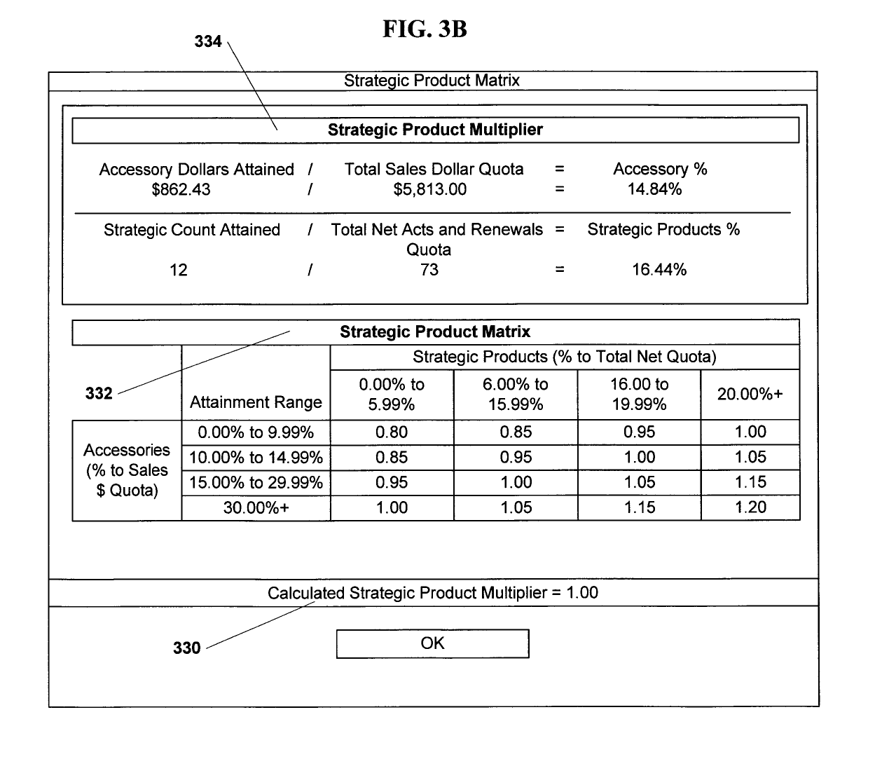

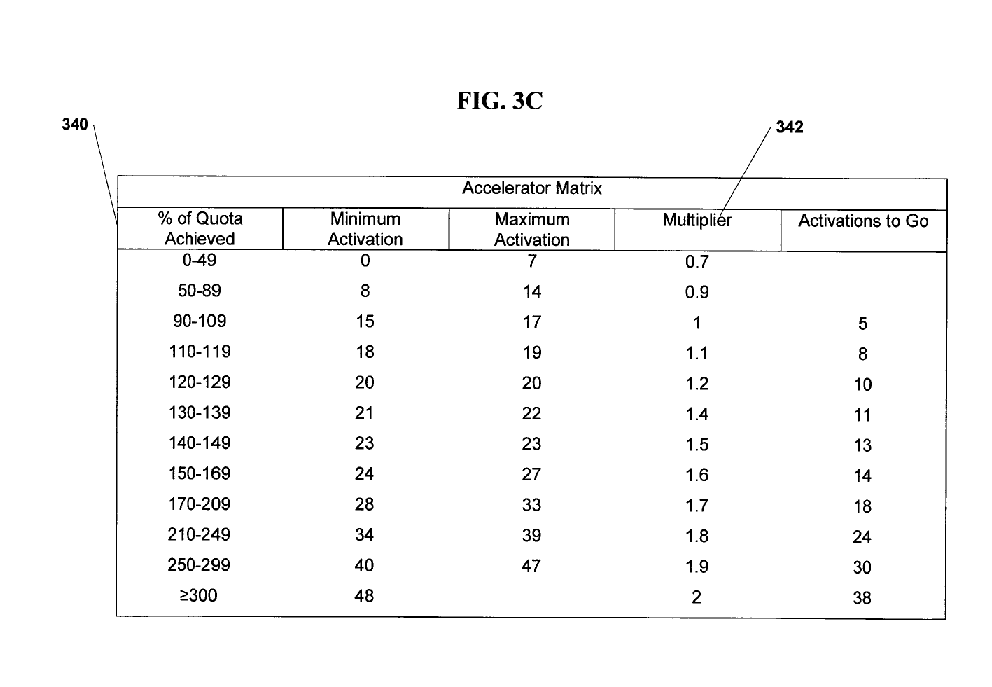

FIGS. 3A through 7C depict interfaces according to exemplary embodiments. The interfaces may be GUIs that may be displayed and interacted with on a computing system as described above. Using these exemplary interfaces, the method 200 may be executed as described above. The interfaces depicted in the figures contain data and information for illustrative purposes only. Accordingly, the layout and content of these interfaces is meant to be exemplary and non-limiting.

FIG. 3A depicts a commission tracker. The commission tracker may be selected using a tab 300 as shown. In some embodiments, the commission tracker may be displayed by default when the interface of FIG. 3A is displayed. A highlight around the tab 300 may indicate that the commission tracker interface is active.

At 302, the days scheduled, days worked, and days remaining may be displayed. These fields may be prepopulated based on received data from one of the input data streams. For example, this data may be received from a resource central database containing scheduling data for a calendar month including shift times, dates and locations.

The button 304 may display a strategic product matrix. The strategic product matrix is depicted in FIG. 3B. This matrix may appear as a pop-up window over the interface of FIG. 3A. The strategic product matrix may calculate a strategic product multiplier 330. This multiplier may be applied to calculate the commission. The strategic product multiplier is calculated based the intersection in the strategic product matrix section 332 of accessory dollars attained divided by a total sales dollar quota to derive a percentage compared to the strategic sales count attained divided by a total net accounts and renewals quota which derives a second percentage. The multiplier 330 is derived based on the preceding data. The calculation of the data to derive the strategic product multiplier 330 is depicted at section 334. The strategic product multiplier 330 may then be applied to the commission value. The data input to the strategic product matrix may be from the database for monthly Quota, Return Rate Matrix, Net Add Performance Matrix and Month-to-date results for each measured component of the entity's sales and retail business. For example, as depicted in FIG. 3B, the Accessory % is 14.84 and Strategic Products % is 16.44%, resulting in a multiplier of 1.0. Thus, if a bonus was at $1,200 and then the bonus paid would still be $1200 ($1200×1.0). The commission tracker may use these estimates in the payout calculations for the bonus. It can be seen that multipliers may be less than or greater than one, leading to either decreased or increased bonus amounts.

The button 305 may display the accelerator matrix. An accelerator matrix is depicted in FIG. 3C. This matrix may appear as a pop-up window. This matrix may function in a similar manner to the strategic product matrix. The accelerator matrix may involve new account activations. The matrix depicted in FIG. 3C may have a set of columns 340. These columns 340 may depict ranges of activations as compared to the Quota % for an employee. A multiplier 342 may be determined as depicted. This multiplier may be applied to a bonus in the manner described above. The data may be input from the database for monthly Quota, Return Rate Matrix, Net Add Performance Matrix and Month-to-date results for each measured component of the entity's sales and retail business

At 306, commission information may be displayed such as commission target, individual commission estimate, commission trend, multiplier trend, and strategic multiplier trend. The commission target may be the “at-risk” dollars from the input data such as the database containing monthly Quota, Return Rate Matrix, Net Add Performance Matrix and Month-to-date (MTD) results for each measured component of the entity's sales and retail business. The individual commission estimate may display the commission estimate if an individual's goals, as set within the commission tracker, are met. The commission trend may display a forecast for an end-of-month commission based on the month to date performance. The multiplier trend may display an estimate of the end of month gross multiplier based on the current run rate based on the accelerator matrix. The strategic multiplier trend may display an estimate of the end-of-month strategic multiplier based on the current run rate based on the strategic product matrix.

At 308, a commission tracker column may display a listing of data that is being tracked for commission purposes. For example, the data depicted in FIG. 3A may be displayed.

At 310, quota fields may be displayed that are pre-populated with data from the data input and contain month-to-date data.

At 312, individual goals may be displayed. The individual goals may be entered by a user. According to exemplary embodiments, the individual goals may be entered at the beginning of the month and may be modified over the course of the month. As depicted in FIG. 3, the individual goals may be entered using a slider bar to select a value for the particular individual goal.

At 314, month-to-date information may be displayed. The month-to-date information may be received from the database containing monthly Quota, Return Rate Matrix, Net Add Performance Matrix and Month-to-date.

At 316, the individual run rate to goal and individual daily required may display the month-to-date run rate and daily required vs. goal/quota. These columns may be calculated as described above.

At 318, the daily actual may display gross adds and renewal performance in real time. This data may be received from the point of sale database that provides real-time daily performance directly from the point-of-sale system for each employee of the entity

The buttons at 320 may allow for the toggle of views between quota and individual goal for the displayed data such as at 316.

At 322, the total sales dollars throughout a day may be estimated.

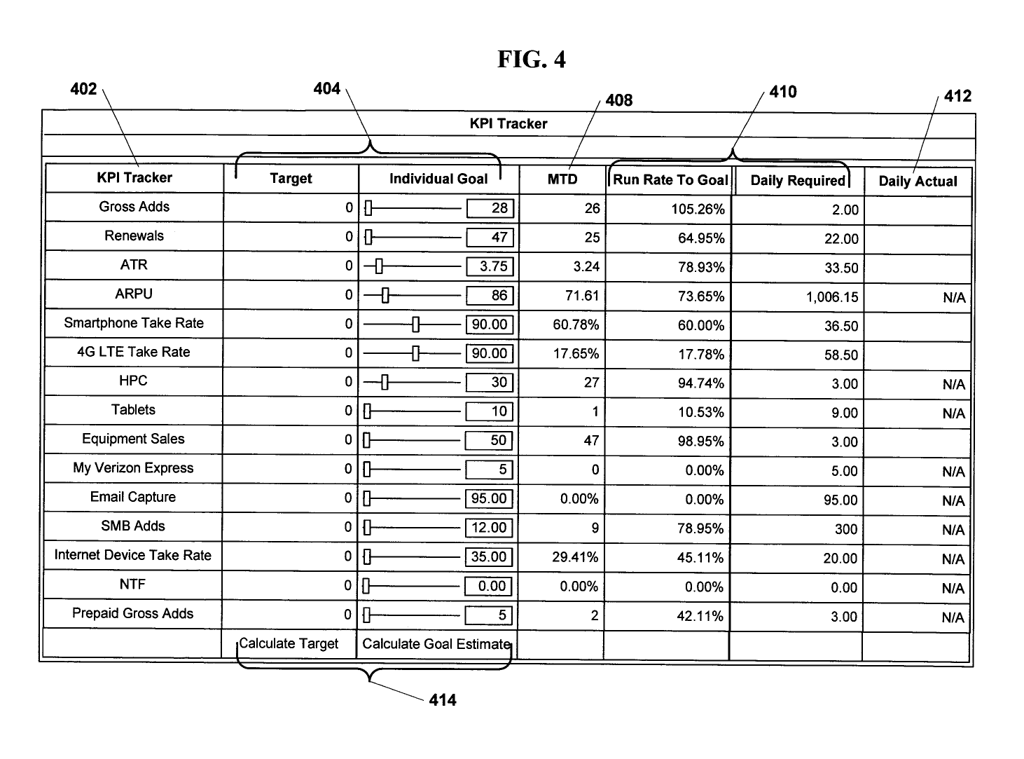

FIG. 4 depicts a KPI tracker.

At 402, a KPI tracker column may display the various KPIs that are being tracked. For example, the KPIs may include what is shown in FIG. 4. The KPIs tracked may include Gross Adds, Renewals, Accessory Take Rate (ATR), Average Revenue Per User (ARPU), Smartphone Take Rate, 4G LTE Take Rate, Home Phone Contact (HPC), Tablets, Equipment Sales, My Verizon Express, Email Capture, Small Business Gross Adds (SMB Adds), Internet Device Take Rate, No Trouble Found (NTF), and Prepaid Gross Adds. It should be appreciated that these fields are exemplary and can be added to, altered, or updated as required.

At 404, the target and individual goal fields may be displayed. This information may be entered at the beginning of the month and may be modified as needed throughout the month. The information for the target may be set by the entity and the individual goal may be set by the employee. As depicted, the individual goal may be set user a slider bar to select a value for the particular individual goal.

At 408, month-to-date information may be displayed. The month-to-date information may be received from the database containing monthly Quota, Return Rate Matrix, Net Add Performance Matrix and Month-to-date.

At 410, the individual run rate to goal and individual daily required may display the individual's month-to-date run rate and daily required vs. target and individual goal.

At 412, the daily actual may be display that is the individual's KPI performance in real time.

The buttons at 414 may allow for the toggle of views between target and individual goal for the displayed data such as at 410.

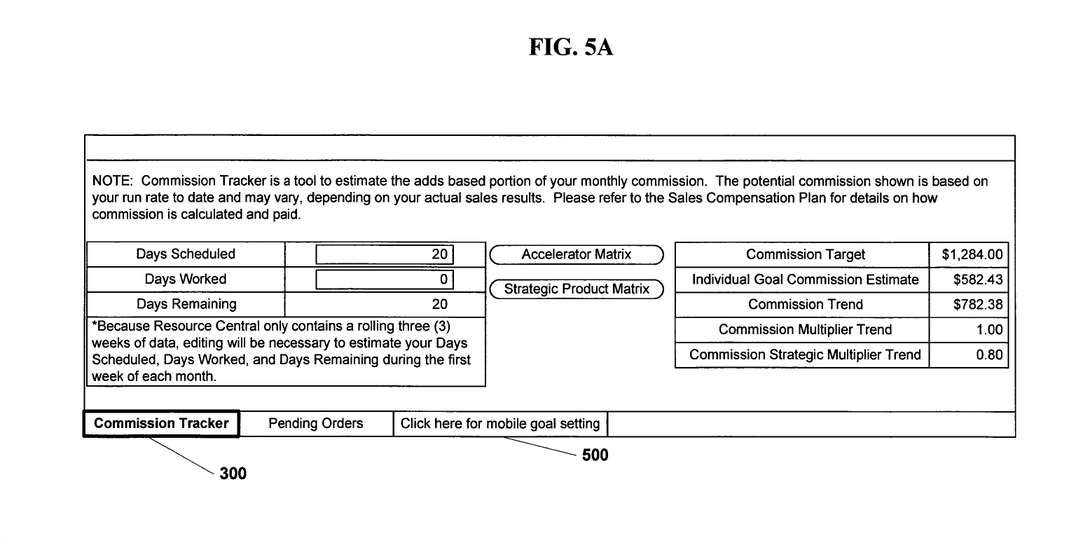

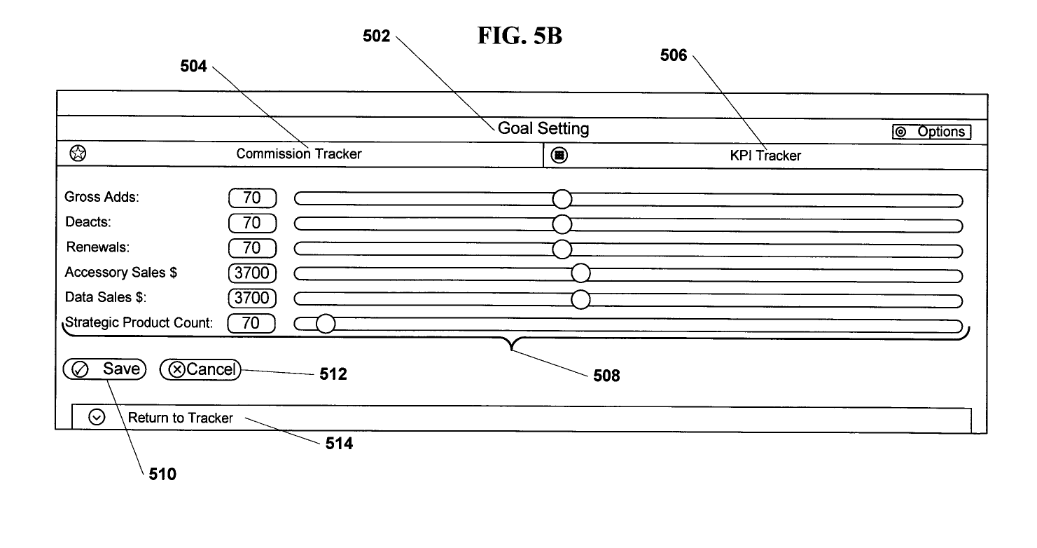

FIGS. 5A and B depict a mobile goal setting interface. This interface may be selected using a tab 500. As depicted in FIG. 5A, the tab 500 may be part of the same tab set as the tab 300 and thus may be accessed from the commission tracker interface of FIG. 3. The tab 500 may be displayed only when the interface is used on a mobile device. For example, the tab 500 may be available when the interface is displayed on a tablet computing device, a laptop/netbook computing device, or a smart phone.

Once the tab 500 is selected, the goal setting interface 502 may be displayed. Two tabs 504 and 506 for goal setting for the commission tracker and the KPI tracker, respectively, may be available. Upon selection of a tab 504 or 506, a set of slider bars 508 may be displayed. Using these slider bars 508 the appropriate goals may be configured. The slider bars 508 may be optimized to make setting goals easier on a mobile device. The slider bars 508 may be responsive to touch screen capability. This is in contrast to the slider bars of FIGS. 3 and 4 that may be manipulated by a pointing device.

A save button 510 and a cancel button 512 may be present to enable saving and cancelling of the selections respectively. The return button 514 may enable the user to return to the previous interface.

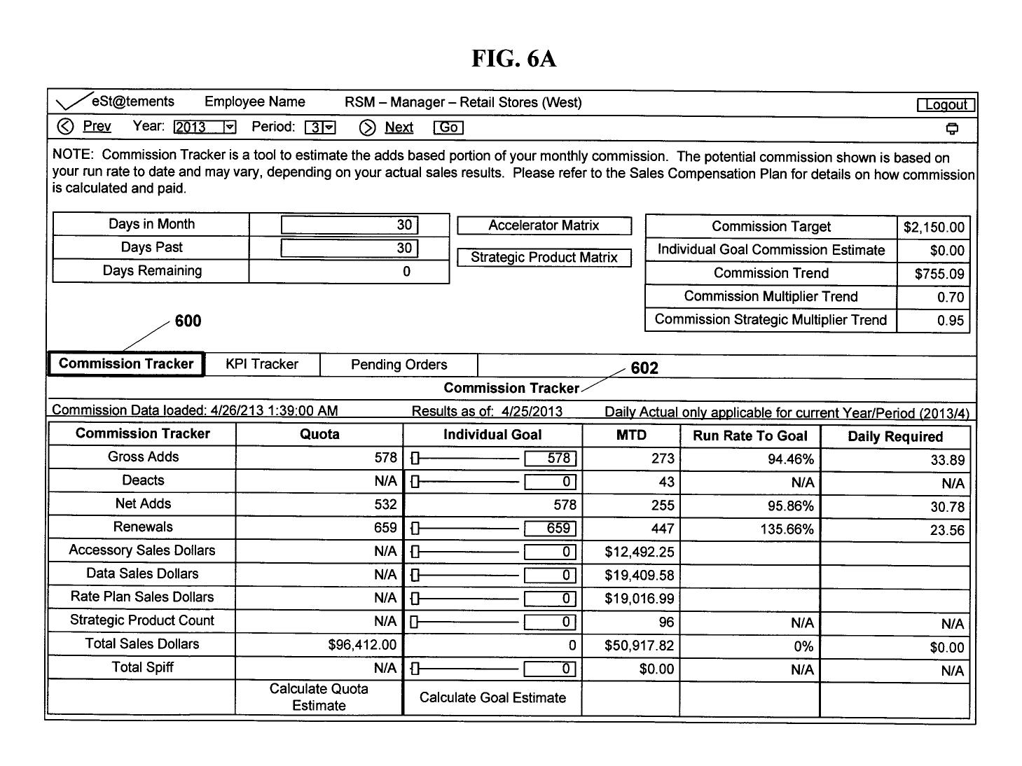

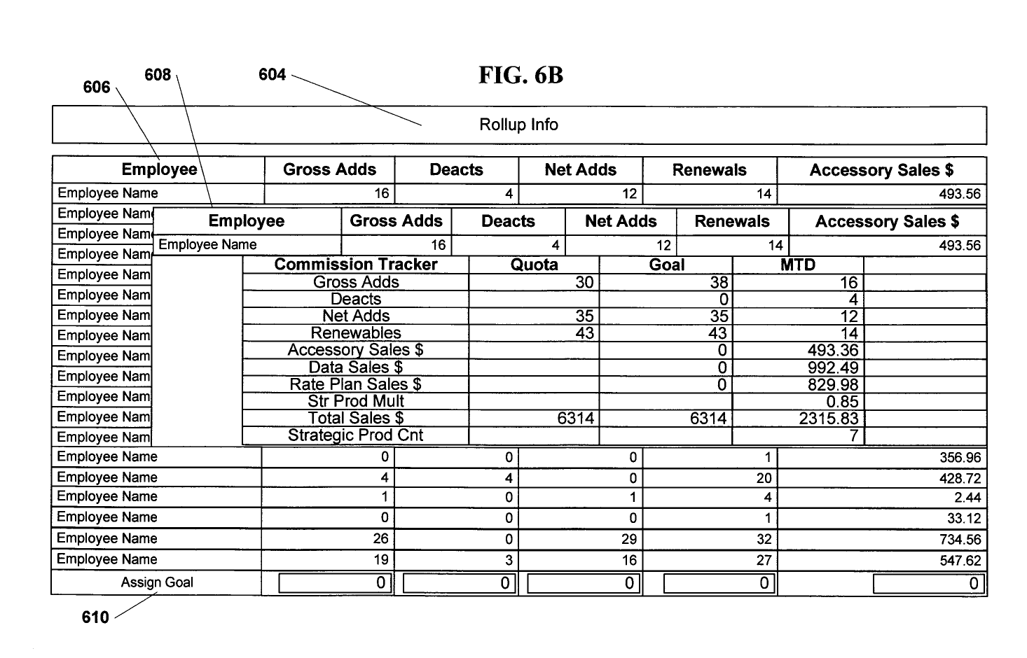

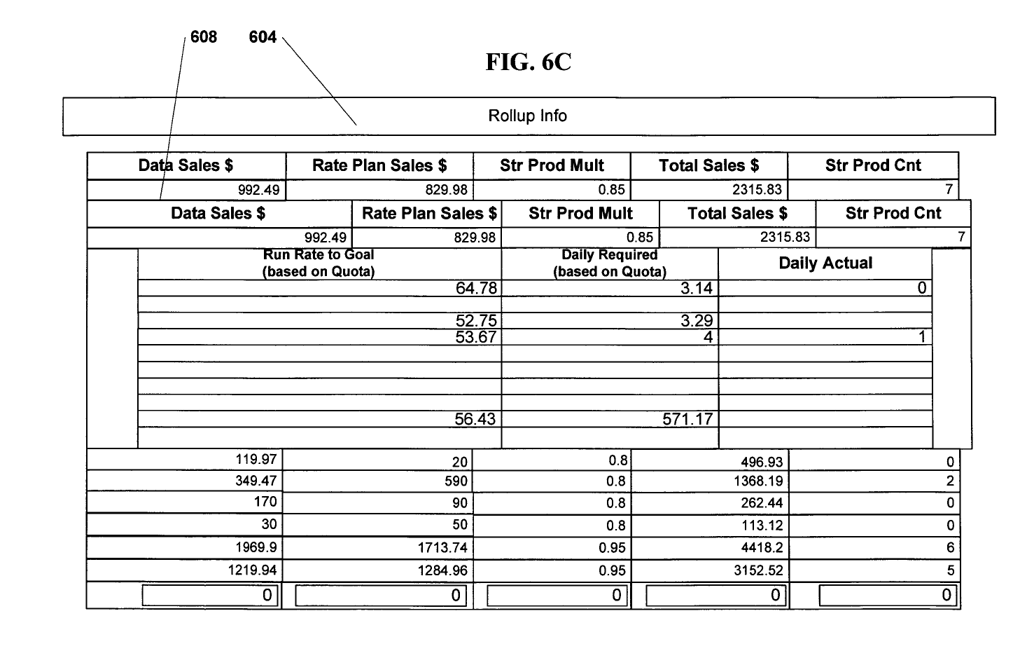

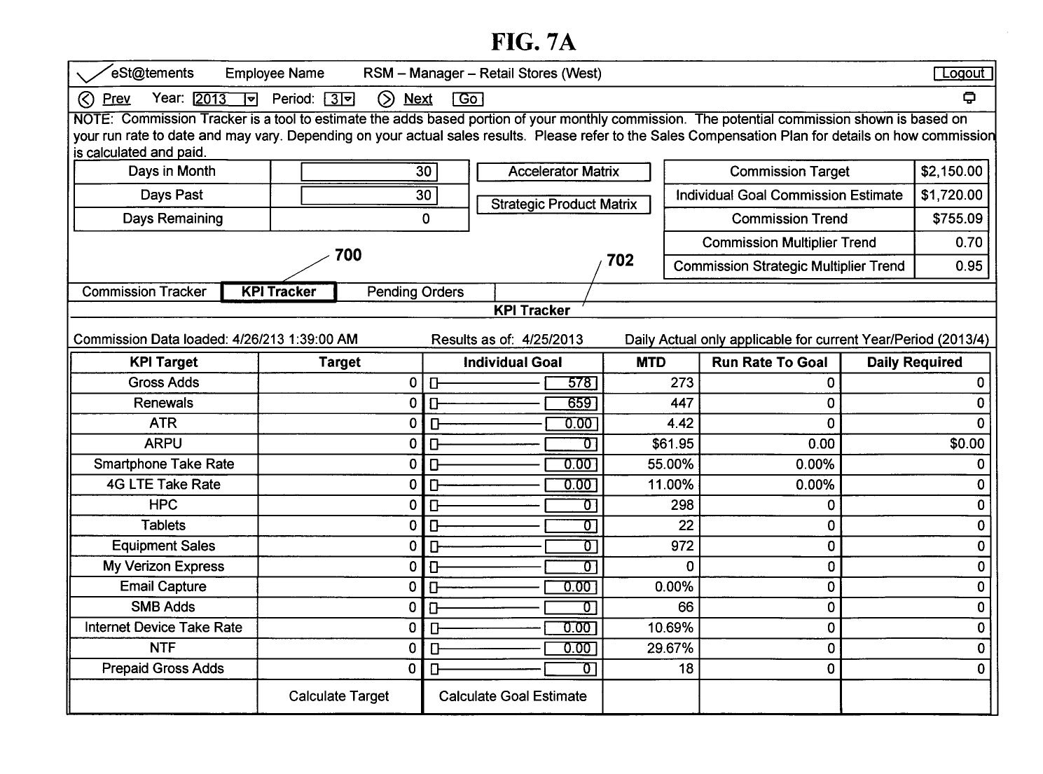

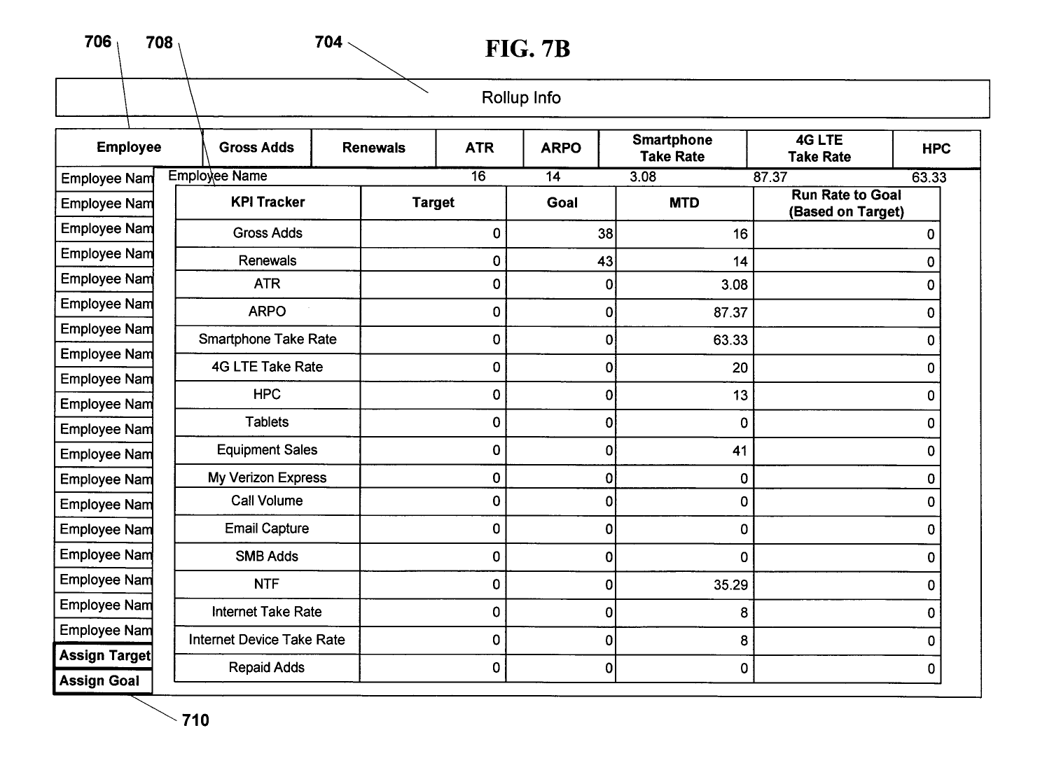

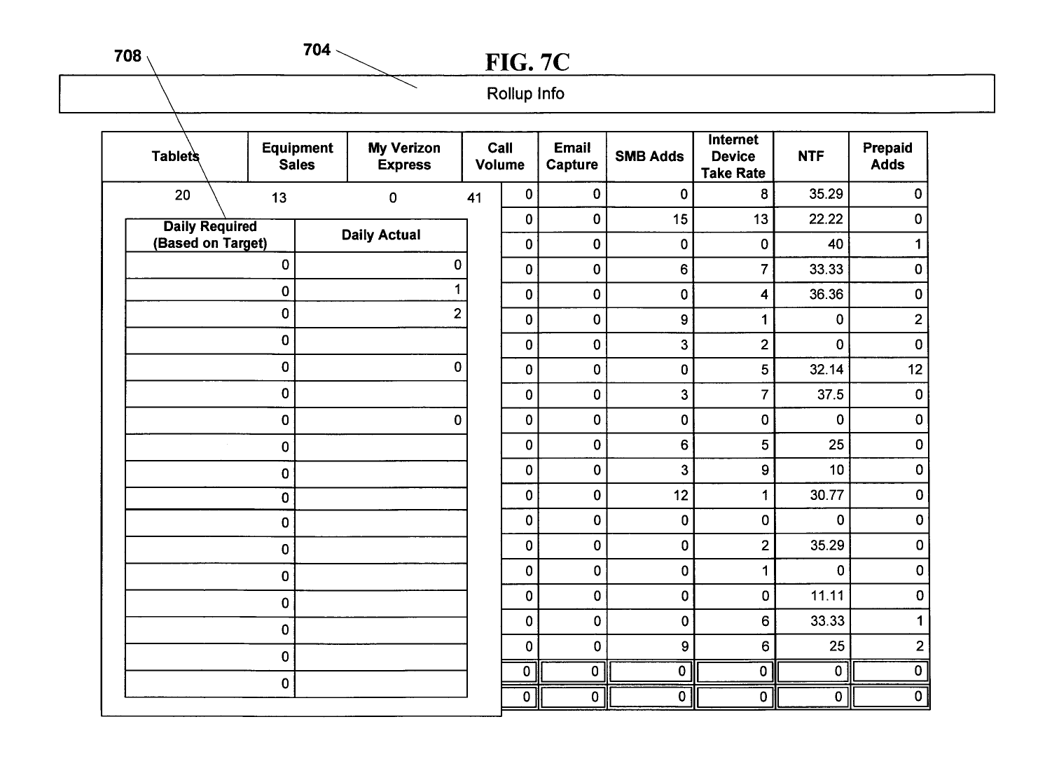

FIGS. 6 and 7 depict manager views of the commission tracker and KPI tracker of FIGS. 3 and 4, respectively. These manager views may enable a manager or supervisor to view a summary of their direct reporting employee commissions and KPIs. The commission tracker and KPI tracker are selected using separate tabs 600 and 700 from a home interface. As can be seen in FIGS. 6 and 7, the views are similar to those of FIGS. 3 and 4.

In FIG. 6A, the information displayed in the commission tracker 602 may be the same as that of FIG. 3. This information may be for the manager's as an individual employee (that is, the manager's own individual data).

FIG. 6B depicts a rollup information view 604 that is displayed to the manager of the data for their direct report employees. This display may be at the lower portion of a screen at the same time as FIG. 6A. In this view, an employee's name may be selected from the employee column 606. Following the selection, a commission summary window 608 may pop-up or open with the data pertaining to the selected employee. The button 610 may allow the manager to assign goals to their employees. The columns from FIG. 6B are continued on FIG. 6C, which is an extension of the rollup information view 604. According to exemplary embodiments, this data may be displayed on the same screen as FIG. 6B.

In FIG. 7A, the information displayed in the KPI tracker 702 may be the same as that of FIG. 4. For example, the KPI targets may include Gross Adds, Renewals, ATR, ARPU, Smartphone Take Rate, 4G LTE E Take Rate, HPC, Tablets, Equipment Sales, My Verizon Express, Email Capture, SMB Adds, Internet Device Take Rate, NTF, and Prepaid Gross Adds. It should be appreciated that these fields are exemplary and can be added to, altered, or updated as required. This information may be for the manager as an individual; that is, the information may relate to the manager's own performance instead of that of his/her employees.

FIG. 7B depicts a rollup information view 704 that is displayed to the manager of the data for their direct report employees. This display may be at the lower portion of a screen at the same time as FIG. 7A. In this view, an employee's name may be selected from the employee column 706. Following the selection, a KPI summary window 708 may pop-up or open with the data pertaining to the selected employee. The buttons 710 may allow the manager to assign targets and goals to their employees. The columns from FIG. 7B are continued on FIG. 7C, which is an extension of the rollup information view 704. According to exemplary embodiments, this data may be displayed on the same screen as FIG. 7B.

In the preceding specification, various preferred embodiments have been described with references to the accompanying drawings. It will, however, be evident that various modifications and changes may be made thereto, and additional embodiments may be implemented, without departing from the broader scope of invention as set forth in the claims that follow. The specification and drawings are accordingly to be regarded in an illustrative rather than restrictive sense.

We claim:

1. A system, comprising:
a processor; and
a memory comprising computer-readable instructions which when executed by the processor cause the processor to perform the steps comprising:
receiving input data, over a computer network, comprising one or more distinct pieces of individual data, from one or more separate and distinct data sources that are not communicatively coupled to one another, wherein the input data comprises data related to employee performance of employees of an entity and key performance indicators established by the entity;
transforming the input data into processed data, wherein the processed data comprises additional metrics relating to employee performance;
receiving a request, from an employee or manager of the entity, for the processed data and the input data from a remote computing device; and
transmitting the processed data and the input data to the remote computing device.

2. The system of claim 1, further comprising:
transmitting updated input data and updated processed data to the remote computing device,
wherein the updated input data and the updated processed data are transmitted following receipt of the updated input data from at least one of the one or more separate and distinct data sources, wherein the updated input data is pulled by the system at a predetermined interval or based on a request for the updated input data transmitted by the processor.

3. The system of claim 2, wherein the predetermined interval is set based on network loading such that other traffic on the computer network does not experience interference.

4. The system of claim 1, wherein the employee or manager is required to provide authentication as part of the request.

5. The system of claim 1, wherein the key performance indicators are stored in a database and are predetermined.

6. The system of claim 1, wherein the key performance indicators are based on geographic location.

7. The system of claim 5, wherein the key performance indicators are updated by the entity based on changing business conditions.

8. A computer-implemented method, comprising:
receiving, electronically by a computing system, input data, over a computer network, comprising one or more distinct pieces of individual data, from one or more separate and distinct data sources that are not communicatively coupled to one another, wherein the input data comprises data related to employee performance of employees of an entity and key performance indicators established by the entity;
creating, by a computer processor, processed data from the input data, wherein the processed data comprises additional metrics relating to employee performance;
receiving, electronically, a request, from an employee or a manager of the entity, for the processed data and the input data from a remotely located computing device that is remotely located with respect to the computing system; and
transmitting, electronically, the processed data and the input data to the remotely located computing device.

9. The method of claim 8, wherein the one or more data sources comprises four distinct data sources

10. The method of claim 8, wherein the remotely located computing device is a mobile computing device.

11. The method of claim 8, further comprising:
transmitting updated processed data and updated input data to the remotely located computing device at a predetermined interval following receipt of the updated input data from at least one of the one or more separate and distinct data sources.

12. The method of claim 8, wherein the processed data and the input date are displayed in one or more graphical user interfaces at the computing device.

13. The method of claim 8, wherein the input data is received automatically from each of the one or more separate and distinct data sources data sources.

14. The method of claim 8, wherein the key performance indicators are stored in a database and are predetermined.

15. The method of claim 8, wherein the key performance indicators are based on geographic location.

16. The method of claim 14, wherein the key performance indicators are updated by the entity based on changing business conditions.

17. The method of claim 8, wherein the employee or manager is required to provide authentication as part of the request.

18. The method of claim 8, wherein the input data comprises: days scheduled, days worked, days remaining, quota information, month-to-date performance information, adjusted individual goals in commissionable or managed metrics, and daily actual data.

19. The method of claim 18, wherein the processed data comprises: days remaining, month to date performance deficit, individual commission estimate, individual run rate to goal, commission trend, and individual daily required.

20. A non-transitory computer readable media comprising code to perform the method of claim 8.
